(19) United States
(12) Patent Application Publication
(10) Pub. No.: US 2003/0030523 A1
(43) Pub. Date: Feb. 13, 2003

(54) Regenerative shock absorber

(76) Inventors: Dale K. Bell, Ortonville, MI (US); Dennis A. Kramer, Troy, MI (US)

Correspondence Address: CARLSON, GASKEY & OLDS, P.C., 400 WEST MAPLE ROAD, SUITE 350, BIRMINGHAM, MI, 48009, US

(21) Appl. No.: 09/925,774

(22) Filed: Aug. 9, 2001

(51) Int. Cl. H01F 7/08

(52) U.S. Cl. 335/220

(57) ABSTRACT

A shock absorber comprises a magnetized plunger and a conductive coil disposed about the magnetized plunger. The coil forms a circuit that generates an electromagnetic force so as to damp movement of the magnetized plunger and a wheel coupled to the magnetized plunger. Movement of the magnetized plunger within the conductive coil may itself create a current, which may be stored by a battery for subsequent use.

### BACKGROUND OF THE INVENTION

This invention relates to a shock absorber which utilizes a controlled electromagnetic force to provide variable resistance to the movement of a magnetized plunger associated with the wheel. Further, the system is capable of generating power during times when damping is not required.

Shock absorber systems are currently used to dampen vibrations and shocks from road conditions experienced by a vehicle. Typically, such absorbers employ a mechanical spring, hydraulic piston or air piston to soften these road conditions. However, such systems offer limited ability to adjust the level of damping during the manufacture of the vehicle or, for that matter, during its operation. Thus, a manufacturer must stock a wide variety of shock absorbers to accommodate the particular needs of a vehicle and its operator. A driver also has no opportunity to adjust the damping level of the shock absorbers for changing road conditions.

Additionally, while such suspension systems dissipate energy absorbed from the road, they do not harness this energy. Over the course of a particular drive, a significant amount of energy may, in fact, be absorbed by the vehicle's suspension system. This energy could be harnessed to power the vehicle's electrical systems.

A need exists for a suspension system that offers greater flexibility in adjusting vehicle damping and to harness the energy absorbed by the system rather than merely dissipate it.

### SUMMARY OF THE INVENTION

The present invention employs an electromagnetic magnetized plunger as a shock absorber. This device permits adjustment of the damping force of the shock absorber by adjusting the electromagnetic force experienced by the magnetized plunger. There is no need for altering the physical characteristics of the spring or piston. Moreover, such a shock absorber maybe part of a larger circuit that permits the vehicle to recover energy absorbed by the shock absorber.

The invention comprises a shock absorber having an electromagnetic magnetized plunger and a vehicle ground support, such as a wheel, mechanically connected to the magnetized plunger. A conductive coil creates an electromagnetic field in a variable direction, either along the direction of the magnetic field or against it, controlling the magnetic force experienced by the magnetized plunger. The strength of the electromagnetic field may be adjusted by adjusting the amount of current through the coil or by adjusting the number of coil turns in the circuit.

A switching circuit creates the electromagnetic field by switching the current “on” and “off.” The frequency of switching is preferably higher than the frequency of movement of the magnetized plunger so as to smoothly dampen its movement. A field effect transistor may be employed as a switch.

In addition to absorbing shock, the electromagnetic magnetized plunger may generate current by its movement. As the wheel moves in an “up” and “down” fashion, so too does the magnetic magnetized plunger. The moving magnetized plunger creates current flowing through the coil. This electrical energy may be stored in a battery for subsequent use. Alternatively, this electrical energy may be fed back to provide the damping force, decreasing the amount of electrical energy required to operate the inventive shock absorber.

In sum, an electromagnetic magnetized plunger is coupled to a wheel. The electromagnetic magnetized plunger moves in the same direction as the wheel. Electromagnetic force is generated by coils around the magnetized plunger in an opposing direction to the movement of the magnetized plunger, thereby damping the movement of the magnetized plunger and the wheel.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 shows an embodiment of the invention including magnetized plunger, conductive coil disposed about the magnetized plunger, and vehicle ground support.

FIG. 2 shows a circuit diagram of the embodiment of FIG. 1.

FIG. 3 illustrates a voltage diagram of the current through the coil of FIG. 1.

FIG. 4 illustrates an alternative embodiment of the invention including magnetized plunger, conductive coil, vehicle ground support, and battery.

### DETAILED DESCRIPTION OF THE PREFERRED EMBODIMENT

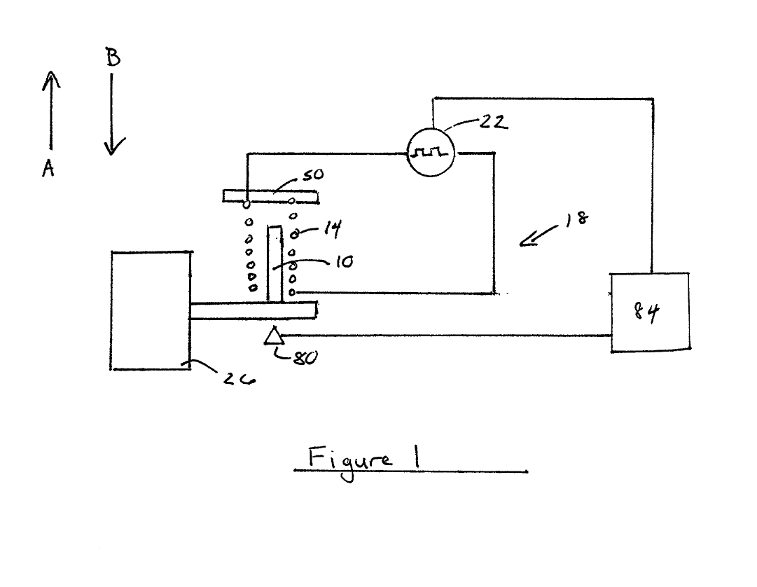

The invention comprises magnetized plunger 10, such as a ferromagnetic magnetized plunger, conductive coil 14, circuit 18, current source 22, and vehicle ground support 26, such as a wheel. As shown schematically in FIG. 1, magnetized plunger 10 is associated with wheel 26. Coil 14 is fixed to a frame element 50, shown schematically. Alternatively, one of ordinary skill in the art may arrange coil 14 to be cooperatively connected to wheel 26 and magnetized plunger 10 to be operatively connected to frame element 50. In either case, wheel 26 moves during operation of a vehicle associated with wheel 26, magnetized plunger 10 moves relative to the coil 14.

Magnetized plunger 10 naturally generates a magnetic field along a predetermined direction, say in direction of arrow B. This direction may alternatively be along arrow A. During vehicle operation, wheel 26 moves in a direction along arrow A or arrow B. The present invention employs conductive coil 14 to create an electromagnetic field and consequent force on magnetized plunger 10 so as to slow movement of wheel 26. By controlling the movement of magnetized plunger 10, the movement of wheel 26 may be damped. Hence, if wheel 26 moves in direction of arrow A, then conductive coil 14 generates an electromagnetic field in the same direction as the magnetic field of magnetized plunger, along arrow B, thereby creating an electric magnetic force in the direction of arrow B.

On the other hand, if wheel 26 moves in direction of arrow B, then conductive coil 14 generates an electromagnetic field in direction of arrow A opposite to the magnetic field of magnetized plunger 10. The net magnetic field results in an electromagnetic force in the direction of arrow A, opposing the movement of wheel 26. The level of this force may be adjusted by the number of turns of coil 14 or by adjusting the level of current through circuit 18. To generate the electromagnetic field, current source 22 is preferably a switching circuit. Current source 22 may also alternate the direction of current so as to change the direction of the electromagnetic field. Current source 22 may be controlled by control unit 84, which may obtain data on the direction and level of movement of wheel 26 and magnetized plunger 10 to control the amount and direction of the electromagnetic field generated by coil 14. Sensor 80 may sense and supply such data by known components.

FIG. 2 illustrates a circuit diagram of the embodiment of FIG. 1. Shown are magnetized plunger 10, conductive coil 14 disposed about magnetized plunger 10, circuit 18, and current source 22, here a circuit with a field effect transistor. As known, the switching “on” and “off” of current source 22 generates electromagnetic field 30. The direction of current I maybe altered to change the direction of electromagnetic field 30 so as to create an electromagnetic force either along arrow A or arrow B depending on the direction of flow of current I. As mentioned previously, this electromagnetic force is opposite in direction to the movement of magnetized plunger 10.

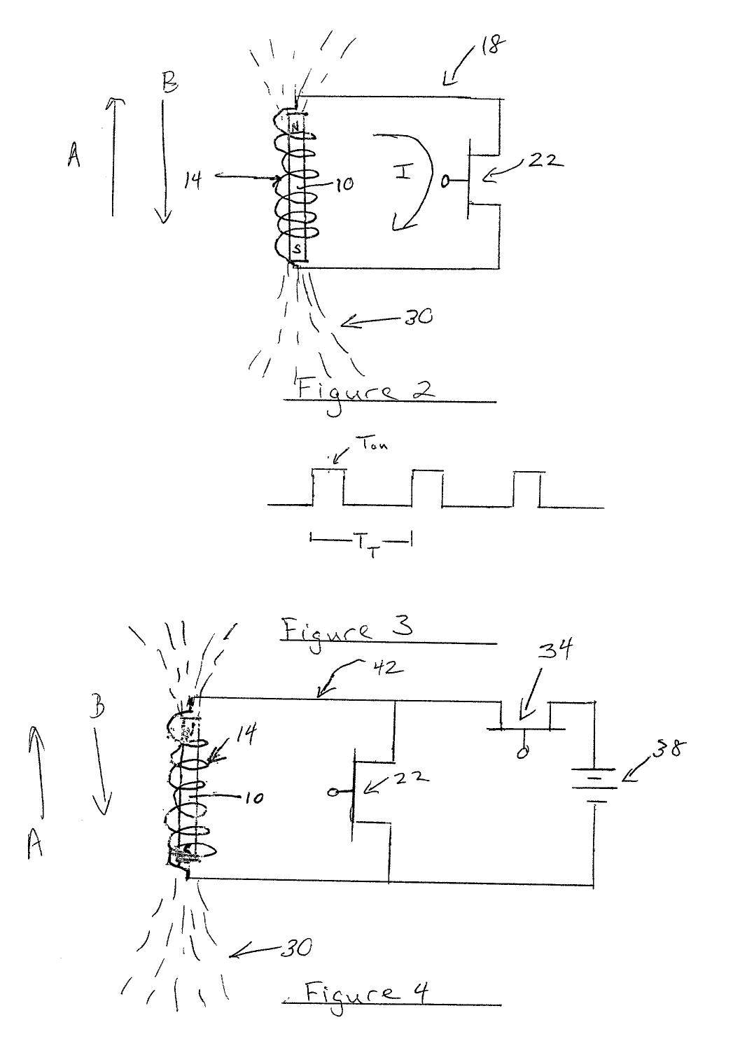

As mentioned above, the strength of the electromagnetic force is directly proportional to the strength of the current. FIG. 3 illustrates a voltage diagram of the current of FIG. 2. Current I is directly proportional to the time period (tₒₙ) that the current is switched “on” and the total period (t) of the square wave. While half wave switching circuits are shown, full wave rectified switching circuits are also possible to work on the full phase of current generation in the coil. Moreover, it is preferable that the frequency of current I be higher than the frequency of oscillation of magnetized plunger 10. In this way, movement of magnetized plunger 10 may be smoothly damped.

In addition to adjusting the strength of electromagnetic force by current strength, the force may be altered by changing the number of a coil in the circuit. One of ordinary skill could alter the number of coils by switching in and out the number of turns on the coil with additional switching circuits. Hence, the strength of the force may be adjusted by adding or decreasing the number of turns of the coil.

During the operation of the vehicle, instances will arise where the amount of electrical energy required to soften the vehicle's ride will be nominal or minimal. In such instances, the vehicle's other suspension elements may adequately damp movement of magnetized plunger 10. Nevertheless, movement of magnetized plunger i10 through conductive coil 14 will generate electricity in the form of a current. This current may be stored by a battery for subsequent use. Preferably, the stored energy may then be used to power coil 14 when damping is next needed.

FIG. 4 illustrates an embodiment incorporating this particular feature. As illustrated previously, conductive coil 14 is disposed about magnetized plunger 10. Current source 22 normally generates current to create electromagnetic field 30 either in the direction of arrow A or arrow B. In addition to these elements, switch 34 controls whether current flows from and to battery 38 from circuit 42. When maximum damping is required, current source 22 is switched “on” while switch 34 is switched “off.” On the other hand, when less damping is required, current source 22 is switched “off” and switch 34 is switched “on,” permitting some current to flow to battery 38 but damping still occurs. As the velocity of magnetized plunger 10 increases, the available electrical energy also increases because the output is proportional to velocity. Accordingly, movement of magnetized plunger 10 may be slowed when load inputs are significant. When significant damping is not required, however, this embodiment permits these road inputs to also charge battery 38. For small displacements of magnetized plunger 10 at low frequency, such as low vehicle speeds on a smooth road, the switching circuit may have to supply coil current from the battery to affect the magnetic damping force required. While battery 38 inserts a small amount of resistance to the circuit, which will modify the current in coil 14, the resistance may be compensated by variations in the duty cycle of switch 34. As shown in FIG. 1, control unit 84 may be used in conjunction with sensor 80 to determine the direction and level of movement of wheel 26. Control unit 84 may thus control switches 22 and 34 and control the level of damping and the charging of battery 38.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention maybe practiced otherwise than as specifically described. For this reason the following claims should be studied to determine the true scope and content of this invention.

What is claimed is:

1. A shock absorber comprising;
a magnetized plunger;
a conductive coil disposed about said magnetized plunger, forming a circuit; and
a vehicle ground with one of said magnetized plunger and said coil fixed to move with said vehicle ground support, and said coil being selectively actuated to provide a magnetic force resisting movement of said vehicle ground support.

2. The shock absorber of claim 1 wherein said vehicle ground support is attached to said magnetized plunger.

3. The shock absorber of claim 1 wherein said conductive coil creates said electromagnetic field about said magnetized plunger so as to slow its movement.

4. The shock absorber of claim 1 wherein said magnetized plunger generates a current in said coil by the movement of said magnetized plunger.

5. The shock absorber of claim 4 including a battery in communication with said circuit.

6. The shock absorber of claim 5 wherein said battery stores electric energy generated by the movement of said magnetized plunger relative to said coil.

7. The shock absorber of claim 1 wherein said circuit comprises a switching circuit.

8. The shock absorber of claim 7 wherein said switching circuit includes a field effect transistor.

9. The shock absorber of claim 8 wherein said switching circuit switches at a higher frequency than the frequency of movement of said magnetized plunger.

10. The shock absorber of claim 1, wherein a control senses movement of said vehicle ground support and selectively actuates said coil when it is desired to resist movement of said vehicle ground support.

11. A shock absorber comprising;
a magnetized plunger;
a conductive coil disposed about said magnetized plunger, forming a circuit; and
a wheel connected to move with said magnetized plunger and said coil selectively actuated to resist movement of said magnetized plunger and hence said wheel; and
a control sensing movement of said wheel and actuating said coil when resistance is desired.

12. The shock absorber of claim 11 wherein said magnetized plunger generates a current in said coil by the movement of said magnetized plunger.

13. The shock absorber of claim 12 including a battery in communication with said circuit.

14. The shock absorber of claim 13 wherein said battery stores electric energy generated by the movement of said magnetized plunger about said coil.

15. The shock absorber of claim 11 wherein said circuit comprises a switching circuit.

16. The shock absorber of claim 15 wherein said switching circuit includes a field effect transistor.

17. The shock absorber of claim 16 wherein said switching circuit switches at a higher frequency than the frequency of movement of said magnetized plunger.

18. A method of shock absorption comprising the steps of:
moving a wheel in a first direction;
generating an electromagnetic force in a second direction opposing said first direction; and
controlling the movement of the wheel through the electromagnetic force.

19. The method of claim 18 including the step of generating electromagnetic energy from the movement of the magnetized plunger.

20. The method of claim 19 including the step of storing the electromagnetic energy.
